(19) United States
(12) Patent Application Publication
(10) Pub. No.: US 2010/0329569 A1
(43) Pub. Date: Dec. 30, 2010

(54) IMAGE PROCESSING PROGRAM, IMAGE PROCESSING APPARATUS, AND IMAGE PROCESSING METHOD

(75) Inventors: Jun ISHIKAWA, Yokohama (JP); Nobuo Takahashi, Yokohama (JP); Wataru Omori, Yokohama (JP); Nobuyasu Akaizawa, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU SEMICONDUCTOR LIMITED, Yokohama (JP)

(21) Appl. No.: 12/824,738

(22) Filed: Jun. 28, 2010

(30) Foreign Application Priority Data
Jun. 29, 2009 (JP) 2009-154098

(51) Int. Cl. G06K 9/68; G06K 9/46

(52) U.S. Cl. 382/195; 382/218

(57) ABSTRACT

An image processing program, which is executable by a computer and is stored in a recording medium readable by the computer, includes: storing one or more features of a plurality of images, each image having a shape defined by a central angle whose origin is a center of a certain image; setting at least one representative shape defined by a central angle whose origin is a center of a search window for scanning a target image; extracting a first value of the one or more features of the representative shape; extracting a second value of the one or more features of one of the plurality of images; and comparing the extracted first value and the extracted second value and determining an image in the search window as an image candidate for the certain image based on a comparison result.

### CROSS-REFERENCE TO RELATED APPLICATIONS

The present Application for Patent claims the benefit of priority from Japanese Patent Application No. 2009-154098 filed on Jun. 29, 2009, the entire contents of which are incorporated herein by reference.

### BACKGROUND

1. Field

Embodiments discussed herein relate to image processing.

2. Description of Related Art

A technique relating to image processing is disclosed in Japanese Laid-open Patent Publication No. 2007-108835, Japanese Laid-open Patent Publication No. 2005-174179, Japanese Laid-open Patent Publication 2007-34876, or the like.

### SUMMARY

According to one aspect of the embodiments, an image processing program which is executable by a computer and is stored in a recording medium readable by the computer is provided. The image processing program includes: storing one or more features of a plurality of images, each image having a shape defined by a central angle whose origin is a center of a certain image; setting at least one representative shape defined by a central angle whose origin is a center of a search window for scanning a target image; extracting a first value of the one or more features of the representative shape; extracting a second value of the one or more features of one of the plurality of images; and comparing the extracted first value and the extracted second value and determining an image in the search window as an image candidate for the certain image based on a comparison result.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an exemplary method for dividing a search image;

FIG. 2 illustrates an exemplary target image;

FIG. 3 illustrates an exemplary search-circle image and a search image;

FIG. 4 illustrates an exemplary image processing apparatus;

FIG. 5 illustrates an exemplary image processing apparatus;

FIG. 6 illustrates an exemplary histogram;

FIG. 7 illustrates an exemplary histogram;

FIG. 8 illustrates an exemplary histogram;

FIG. 9 illustrates an exemplary histogram;

FIG. 10 illustrates an exemplary histogram;

FIG. 11 illustrates an exemplary histogram;

FIG. 12 illustrates an exemplary storing process;

FIG. 13 illustrates an exemplary image recognizing process;

FIG. 14 illustrates an exemplary sector searching process;

FIG. 15 illustrates an exemplary comparing process;

FIG. 16 illustrates an exemplary sector searching process;

FIG. 17 illustrates an exemplary sector searching process; and

FIG. 18 illustrates an exemplary sector searching process.

### DESCRIPTION OF EMBODIMENTS

For a face recognition system, an input image is converted into information that is easy to process, for example, scaled information or gray-scale information. The size of a search window for performing an operation for acquiring a feature is determined. The search window moves from upper left to lower right of the entire image. A mixture Gaussian distribution for acquiring a feature from the central point of the search window using retinal sampling, and the feature is compared with a previously stored feature of a search image. If they match each other to some extent, detailed feature comparison using a Gabor filter is carried out. If the features match each other through the Gabor filter, the target image is determined to correspond to the search image.

When recognizing a particular image from a target image, the image range used in comparison varies depending on a light source, rotation and scale of the image, change in facial expression, and other factors. A search region in the target image may be identified by retinal sampling employing a Gaussian distribution. If retinal sampling is used, a light source, rotation and scale of the image, or change in facial expression is searched for, using a Gabor Wavelets filter.

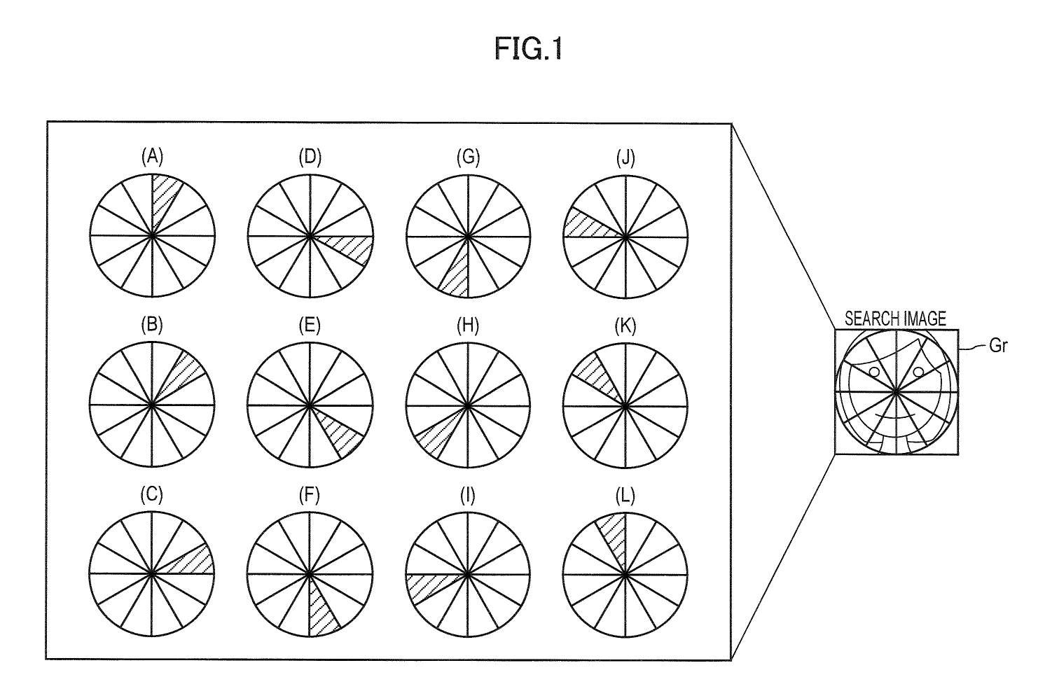

FIG. 1 illustrates an exemplary method for dividing a search image. A search image Gr is compared with a target image to be recognized. The search image Gr includes a face image. The search image Gr is divided into a plurality of sectors, each of which has the origin lying in the central point of the search image Gr. In FIG. 1, the search image Gr includes 12 divisional sector images (A) to (L). The sector images (A) to (L) may be images having substantially the same radius and a central angle of approximately 30 degrees.

For the search image Gr, for example, the direction of 12 o'clock position may be set as 0 degrees, and the central angle may increase in a clockwise direction. In the search image Gr, 0 degrees indicates the direction of the upper region around the head viewed from the center of the face, for example, nose or its adjacent area. The search image Gr includes at least one search image. The search image Gr may be stored in a storage device.

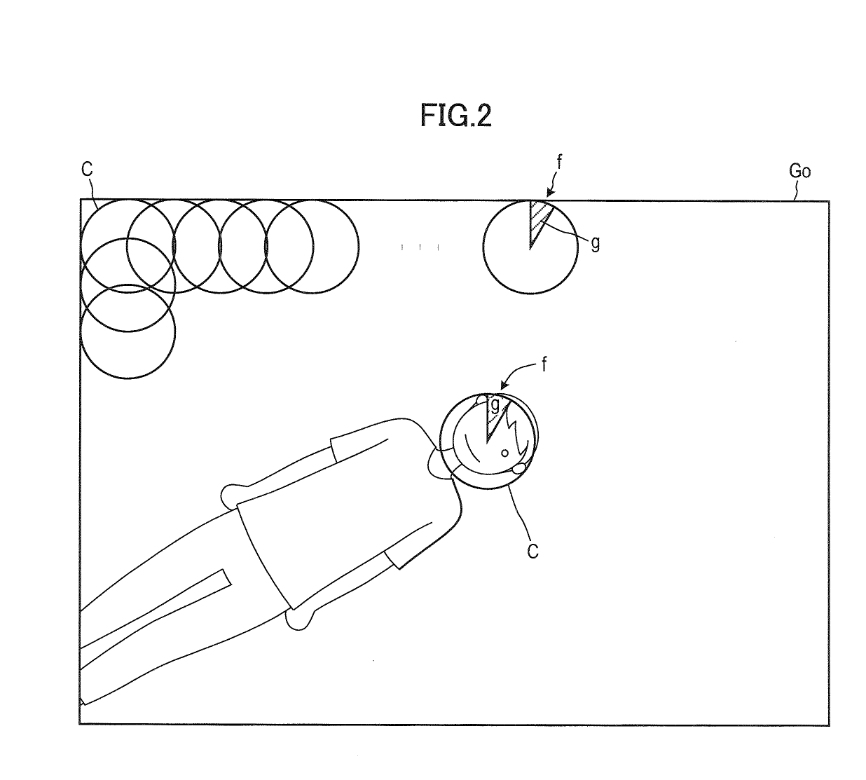

FIG. 2 illustrates an exemplary target image. Each of the circles is a search circle C serving as a search window. A target image Go is scanned using the search circle C, and recognition is performed for each scan position. At the scan position, a sector having a specific radius direction is set. A sector in the search circle C may be referred to as a representative sector f. One or more representative sectors f may be set in the search circle C. Each representative sector f may be a sector having a central angle of approximately 0 to 30 degrees. The central angle of the representative sector f may be substantially the same as the central angle of a sector image of the search image Gr, for example, 30 degrees. The representative sector f and the sector image of the search image Gr may have different central angles.

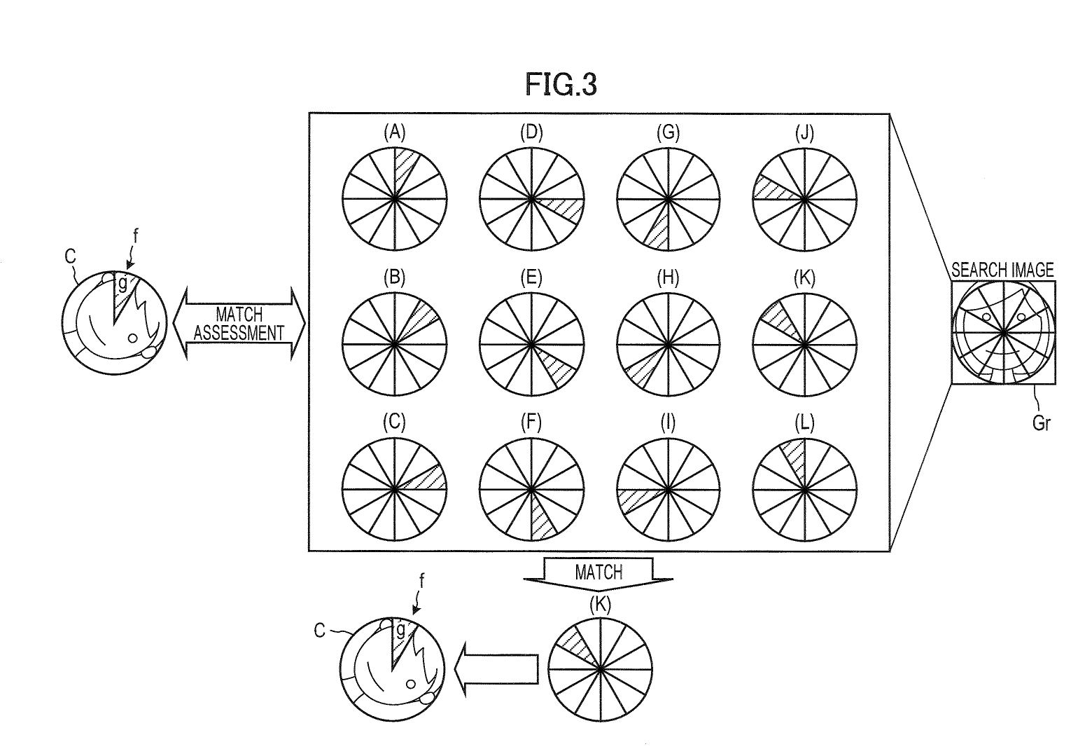

FIG. 3 illustrates an exemplary search circle image and an exemplary search image. The image of the search circle C is compared with an image in the representative sector f, for example, an image g in the representative sector f (hereinafter referred to as inside representative sector image g). For example, the value of features of the inside representative sector image g is compared with that of each of the 12 divisional sector images (A) to (L). Both of the amounts of features may be calculated based on luminance obtained by histogram analysis, for example.

In FIG. 3, the inside representative sector image g and the sector image (K) correspond to the right eye and may be determined to match each other. The inside representative sector image g is considered to be a face image candidate. The inclination of the face image candidate is obtained based on the position of the sector image.

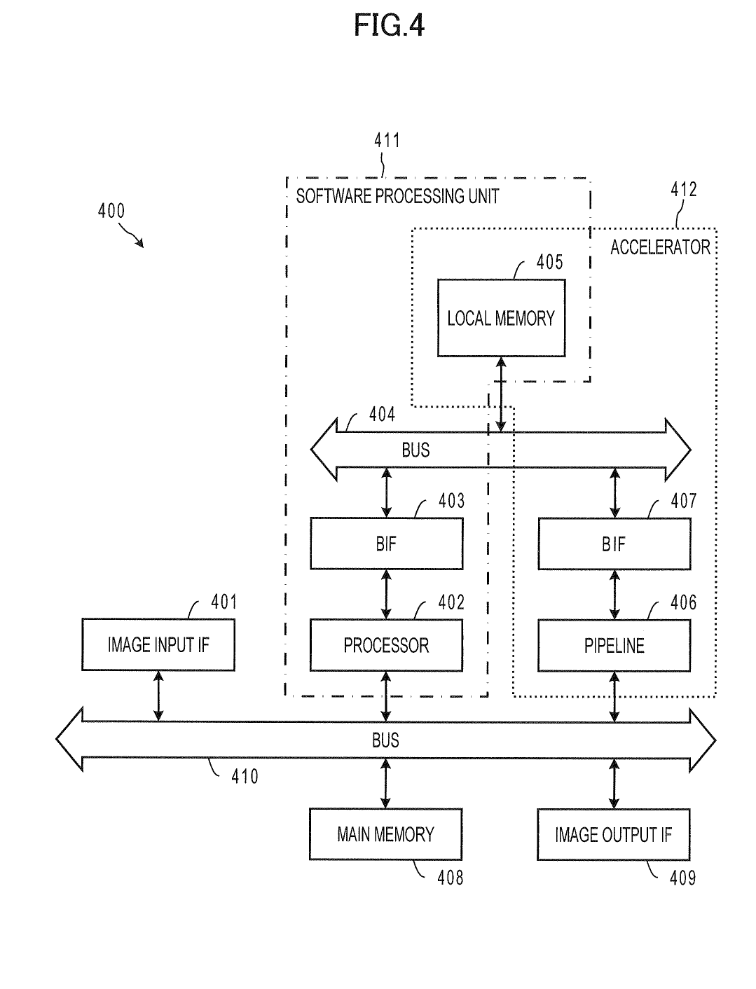

FIG. 4 illustrates an exemplary image processing apparatus. An image processing apparatus 400 includes an image input interface (IF) 401, a processor 402, a bus interface (BIF) 403, a bus 404, a local memory 405, a pipeline 406, a BIF 407, a main memory 408, an image output IF 409, and a bus 410.

The image input IF 401 receives an input image from an outside, for example, a search image Gr or target image Go and stores the input image in the main memory 408 through the bus 410. The processor 402 controls the image processing apparatus 400 entirely. The processor 402 executes an image processing program stored in the main memory 408.

The BIF 403 controls communications between the processor 402 and the bus 404. The bus 404 couples the BIFs 403 and 407 and the local memory 405. The local memory 405 may be used as a work area for the processor 402. The local memory 405 may include a random-access memory (RAM), for example. The processor 402, the BIF 403, the bus 404, and the local memory 405 may be included in a software processing unit 411 for executing software process.

The pipeline 406 executes pipeline process. The pipeline 406 may use the local memory 405 as a work area. The BIF 407 controls communications between the pipeline 406 and the bus 404. The pipeline 406, the BIF 407, the bus 404, and the local memory 405 may be included in an accelerator 412. The accelerator 412 may enlarge, reduce, or rotate an image, for example. The software processing unit 411 also may enlarge, reduce, or rotate an image. The accelerator 412 and the software processing unit 411 may share the local memory 405 and the bus 404.

The main memory 408 stores an image processing program, an input image, a result executed by an image processing program. The main memory 408 may include a RAM, flash memory, and magnetic disk, for example. The image output IF 409 outputs data stored in the main memory 408 on a display in response to an instruction from the processor 402. The bus 410 couples the image input IF 401, the processor 402, the pipeline 406, the main memory 408, and the image output IF 409.

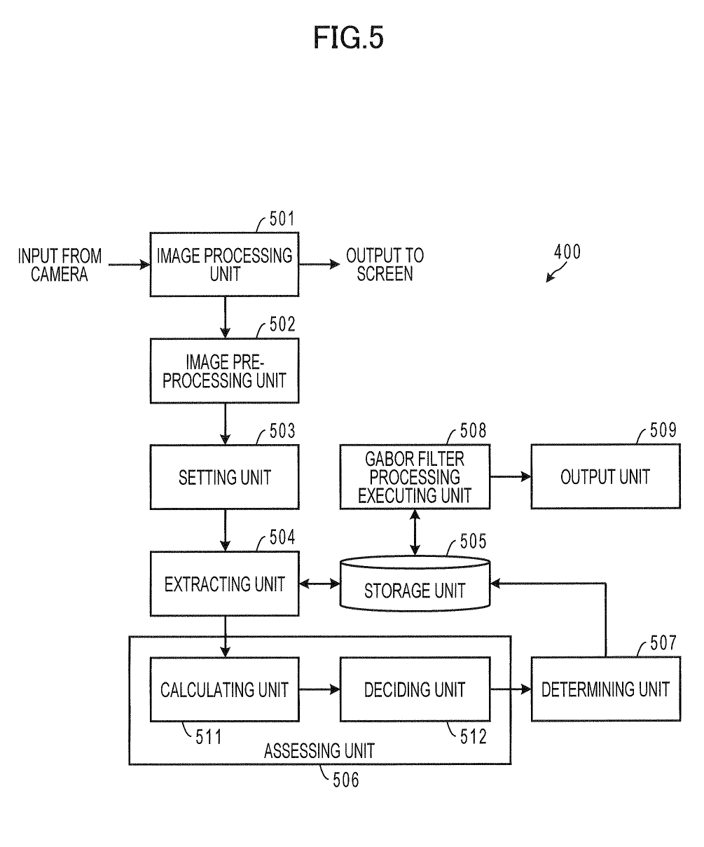

FIG. 5 illustrates exemplary image processing apparatus. The image processing apparatus 400 includes an image processing unit 501, an image pre-processing unit 502, a setting unit 503, an extracting unit 504, a storage unit 505, an assessing unit 506, a determining unit 507, a Gabor filter processing executing unit 508, and an output unit 509. The assessing unit 506 includes a calculating unit 511 and a deciding unit 512.

The image processing unit 501, the image pre-processing unit 502, and the Gabor filter processing executing unit 508 may include the accelerator 412 or the software processing unit 411 illustrated in FIG. 4, for example. The setting unit 503, the extracting unit 504, the assessing unit 506, and the determining unit 507 may include the software processing unit 411 illustrated in FIG. 4. The storage unit 505 may include the main memory 408 illustrated in FIG. 4. The output unit 509 may include the image output IF 409 illustrated in FIG. 4.

The image processing unit 501 stores images input from a camera through the image input IF 401 at specific intervals in the main memory 408. The address of a stored image is identified. The image processing unit 501 outputs output images at specific intervals from the main memory 408 through the image output IF 409.

The image pre-processing unit 502 may enlarge, reduce, rotate, move, gray-scale an input image, or image-transform-filter an input image. The image transform-filtering may include a rank filter and a Gaussian filter. An input image may be gray-scaled, and the gray-scaled image may be subjected to wide-area smoothing. The difference in luminance between the gray-scaled image and the wide-area smoothed image is calculated. The luminance difference image may be stored in the local memory 405 or the main memory 408.

The setting unit 503 stores a search image Gr and sets a representative sector f in a search circle C. The search image Gr is divided into sectors. As illustrated in FIG. 1, the central angle of each of the sectors is set, and the search image Gr is divided into the sectors.

The representative sector f specified by a central angle whose origin is the central point of the search circle C is determined. As illustrated in FIG. 2, a sector having a central angle of approximately 0 to 30 degrees is determined to be the representative sector f.

The extracting unit 504 extracts the luminance of an image as the value of features based on histogram analysis. The value of features of each of the sector images into which the search image Gr is divided is extracted by histogram analysis, and the search image Gr is stored.

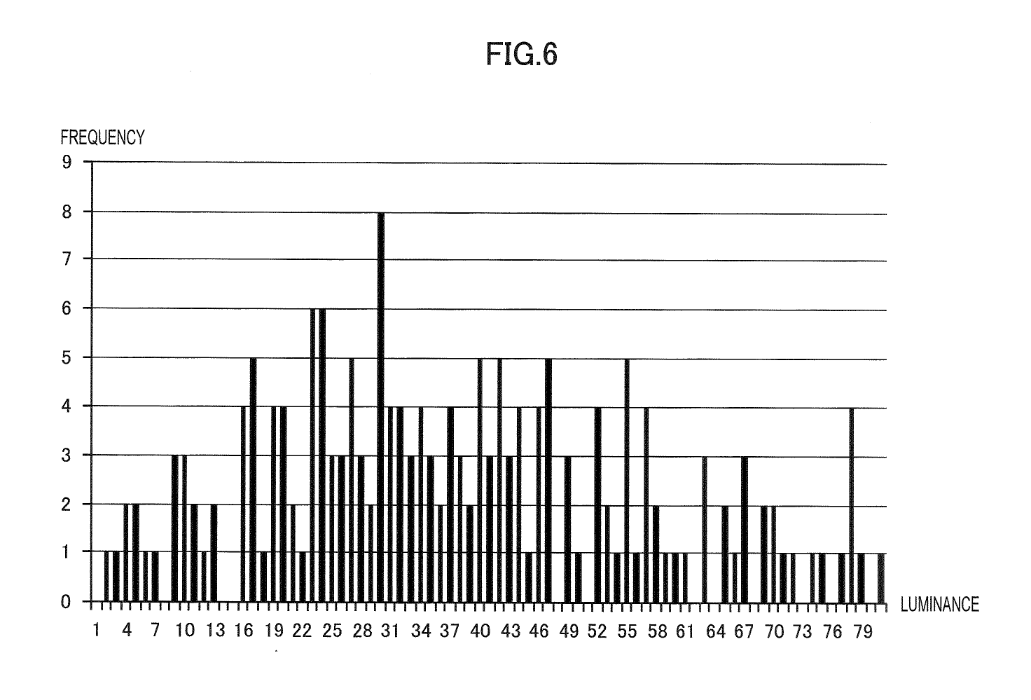

FIG. 6 illustrates an exemplary histogram. The histogram illustrated in FIG. 6 may be a sector-image histogram for the search image Gr. The horizontal axis represents the luminance, whereas the vertical axis represents the frequency of the histogram. The sector-image histogram may be flattened to accommodate the luminance difference.

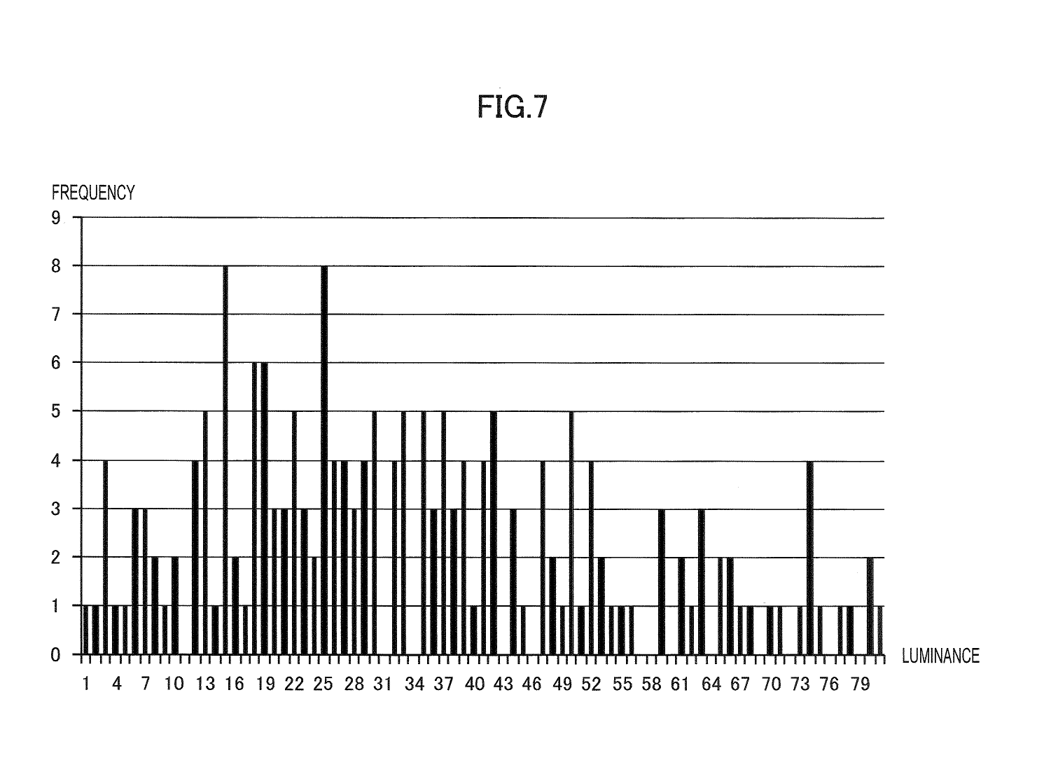

FIG. 7 illustrates an exemplary histogram. The sector-image histogram can be flattened by the following equation (1).

$${R}^{′} ( i ) = R max \frac{{\sum }_{i = 0}^{R} H ( i )}{N} \qquad ( 1 )$$

In equation (1), R(i) denotes an i-th luminance before transformation, R′(i) denotes an i-th luminance after transformation, Rmax denotes the maximum value of the luminance R(i) before transformation, H(i) denotes the number of pixels having the luminance R(i), and N denotes the sum of pixels included in an image.

The extracting unit 504 stores, in the storage unit 505, the histogram illustrated in FIG. 6 or 7 as the value of features for each sector image. For comparison with the image g in the representative sector f, the value of features of the sector image is extracted from the storage unit 505.

The extracting unit 504 extracts the value of features of the image g in the representative sector f by histogram analysis. The extracted value of features, for example, a histogram is stored in the local memory 405.

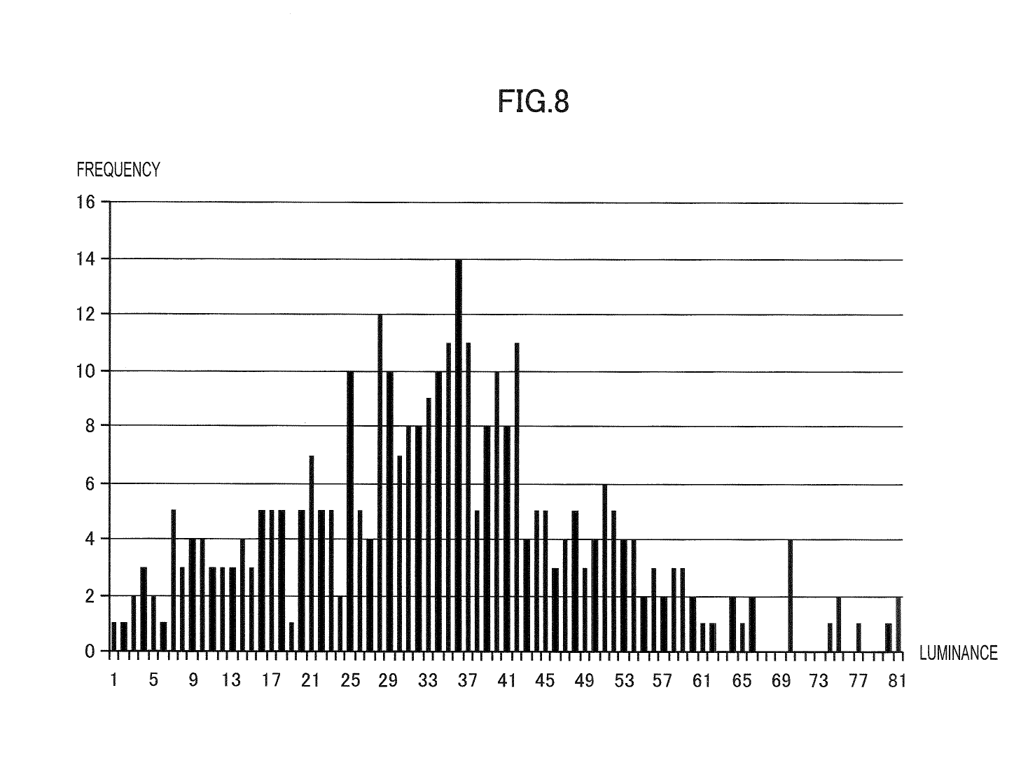

FIG. 8 illustrates an exemplary histogram. The histogram illustrated in FIG. 8 may be a histogram for an inside representative sector image g in the target image Go. The histogram for the inside representative sector image g in the representative sector f may be flattened to accommodate the luminance difference as determined by the equation (1).

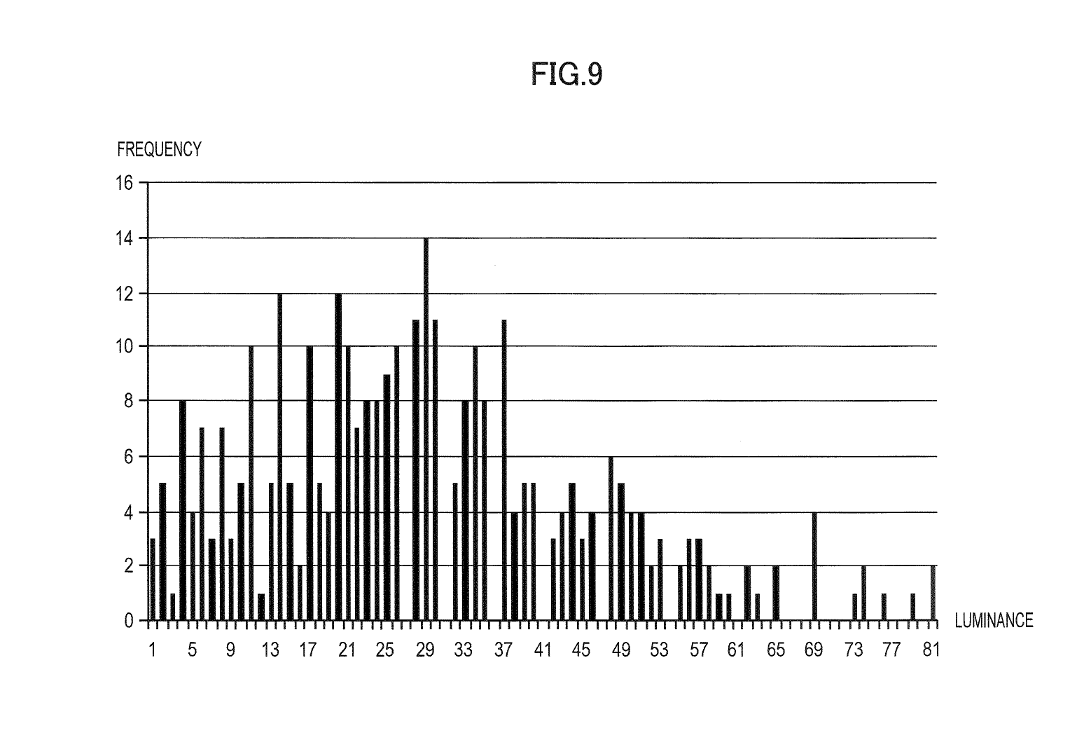

FIG. 9 illustrates an exemplary histogram. The histogram illustrated in FIG. 9 may be a flattened histogram for the inside representative sector image g. The extracting unit 504 extracts the histogram illustrated in FIG. 8 or 9 and stores it in the local memory 405.

The storage unit 505 may be the main memory 408. The storage unit 505 may store the value of features of each of a plurality of sectors, for example, the histogram illustrated in FIG. 6 or 7.

The assessing unit 506 determines whether an inside representative sector image g is present in a plurality of sector images based on the value of features of the inside representative sector image g and the value of features of each of the sector images. The calculating unit 511 calculates a matching degree between the image in the representative sector f and the sector image based on the value of features of the inside representative sector image g and the value of features of the sector image. The calculating unit 511 may summarize the frequency of the histogram for the sector image and that of the histogram for the inside representative sector image g into 5 luminances, for example.

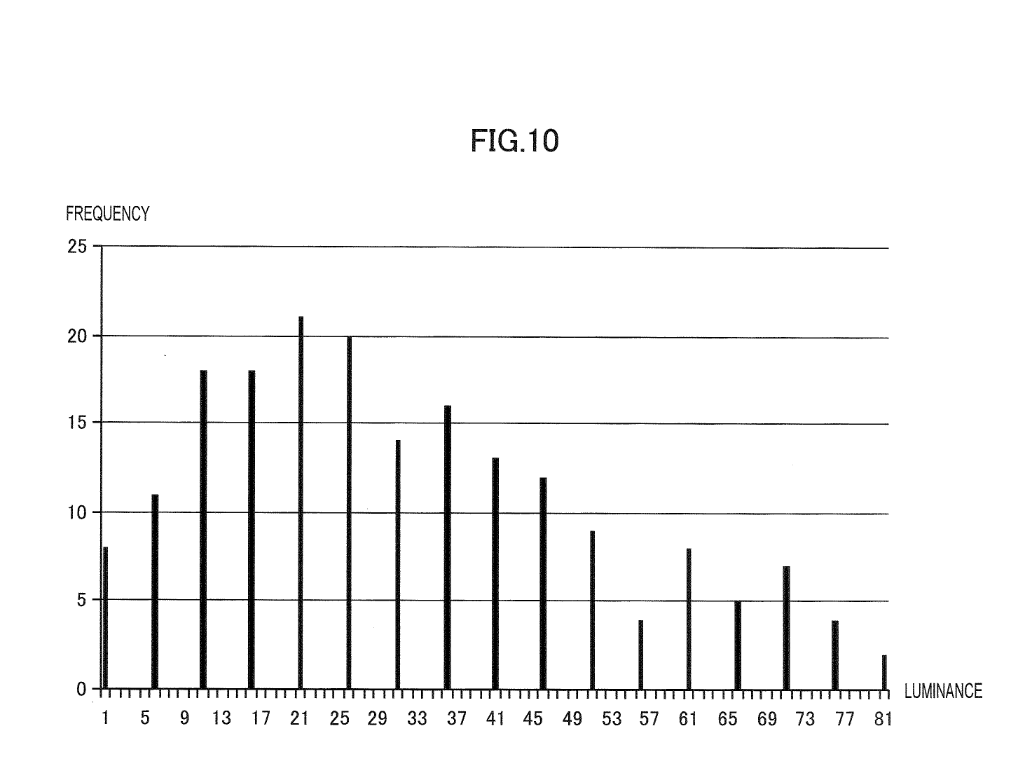

FIG. 10 illustrates an exemplary histogram. The histogram illustrated in FIG. 10 is generated based on the histogram illustrated in FIG. 7. The value of features of a j-th luminance, Psoj, may be calculated by the following equation (2).

Psoj=Dsoj/Dmax/P (2)

In equation (2), Dsoj denotes the frequency of the j-th luminance, Dmax denotes the maximum frequency of all values of luminance before regeneration, and P denotes the total number of pixels.

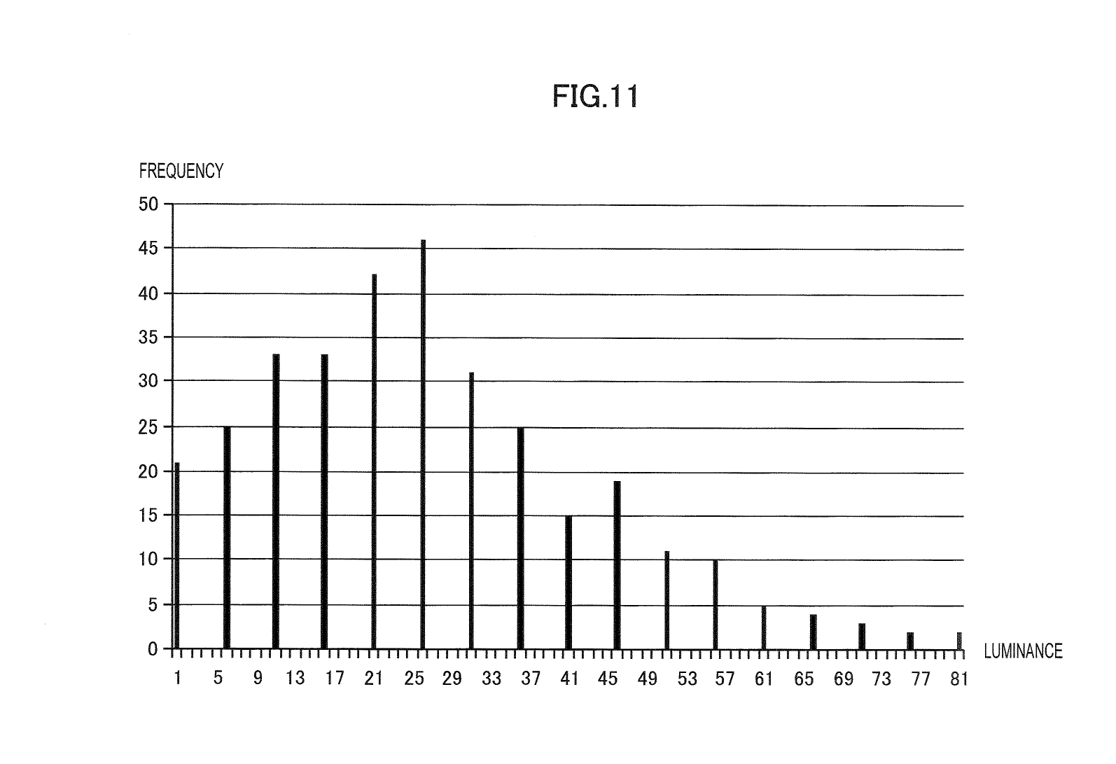

FIG. 11 illustrates an exemplary histogram. The histogram illustrated in FIG. 11 may be a histogram for the inside representative sector image g generated based on the flattened histogram illustrated in FIG. 9, for example. The amount of features of the j-th luminance, Pssj, may be calculated by the following equation (3).

Pssj=Dssj/Dmax/P (3)

In the equation (3), Dssj denotes the frequency of the j-th luminance, Dmax denotes the maximum frequency of all values of luminance before regeneration, and P denotes the total number of pixels.

The calculating unit 511 may calculate the matching degree M between the image in the representative sector f and the sector image by the following equation (4).

$$M = {\sum }_{i = 0}^{h} ( Psoj - Pssj ) \qquad ( 4 )$$

In the equation (4), j denotes the luminance number of the histogram after regeneration, and h denotes the maximum value of the luminance number j.

The deciding unit 512 decides whether the matching degree M calculated by the calculating unit 511 is equal to or larger than a specific threshold Mt. The deciding unit 512 continues making the decision until a sector image that has a matching degree M being greater than or equal to the specific threshold Mt is detected. The assessing unit 506 assesses whether an image that matches the inside representative sector image g is present in a plurality of sector images.

The determining unit 507 determines whether the image in the search circle C is a candidate for the particular image in response to an assessment obtained by the assessing unit 506. For example, when an image that matches the inside representative sector image g is determined to be present in the plurality of sector images, the image in the search circle C is set as a candidate for the particular image. The image in the search circle C is stored in the storage unit 505 as a target for Gabor filter process. When no image that matches the inside representative sector image g is determined to be present in the plurality of sector images, the search circle C is shifted and scanning continues. When the scanning on the entire region of the target image Go is completed, the process ends.

The Gabor filter process executing unit 508 performs a Gabor filter process on an image that is a target for Gabor filter process. The target for Gabor filter process may be recognized as a particular image, for example, face image. The Gabor filter process executing unit 508 may use a known algorithm.

The output unit 509 outputs a determination obtained by the determining unit 507. For example, a result of execution by the Gabor filter process executing unit 508 is output on the display. The image in the search circle C subjected to Gabor filter process is recognized as a particular image, for example, face image.

Prior to face image recognition from the target image Go, as illustrated in FIG. 1, the value of features of the search image Gr, for example, a histogram is stored in the main memory 408. The amount of features may be stored in the image processing unit 501, the image pre-processing unit 502, the setting unit 503, the extracting unit 504, and the storage unit 505 illustrated in FIG. 5.

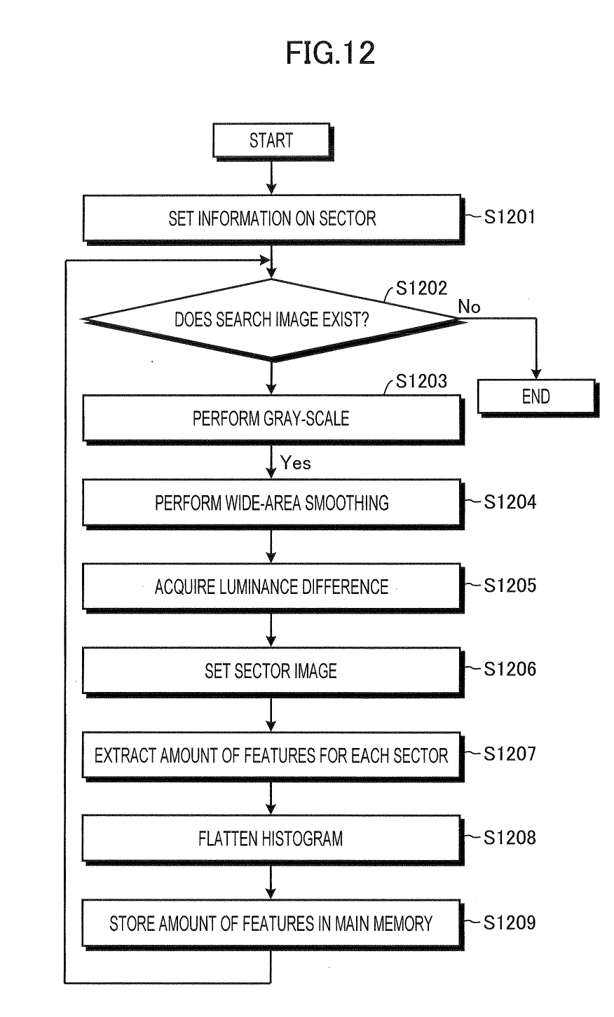

FIG. 12 illustrates an exemplary storing process. In operation S1201, the setting unit 503 sets information on a sector, for example, the central angle and radius of the sector. In operation S1202, the image processing unit 501 decides whether the search image Gr exists. When the search image Gr exists (YES in operation S1202), the image pre-processing unit 502 gray-scales the search image Gr in operation S1203. Then, wide-area smoothing is performed in operation S1204 and luminance difference is acquired in operation S1205.

In operation S1206, the setting unit 503 sets a sector image of the search image Gr whose luminance difference is acquired. In operation S1207, the extracting unit 504 extracts the value of features for each sector image. In operation S1208, the histogram of the extracted value of features is flattened. In operation S1209, the flattened value of features, for example, the histogram is stored in the main memory 408, and the process returns to operation S1202. In operation S1202, when the search image Gr does not exist (NO in operation S1202), the process ends.

As illustrated in FIG. 2 or 3, the target image Go is scanned such that the search circle C moves on the target image Go. For each scan position, it is determined whether the image in the search circle C matches each of a plurality of sector images.

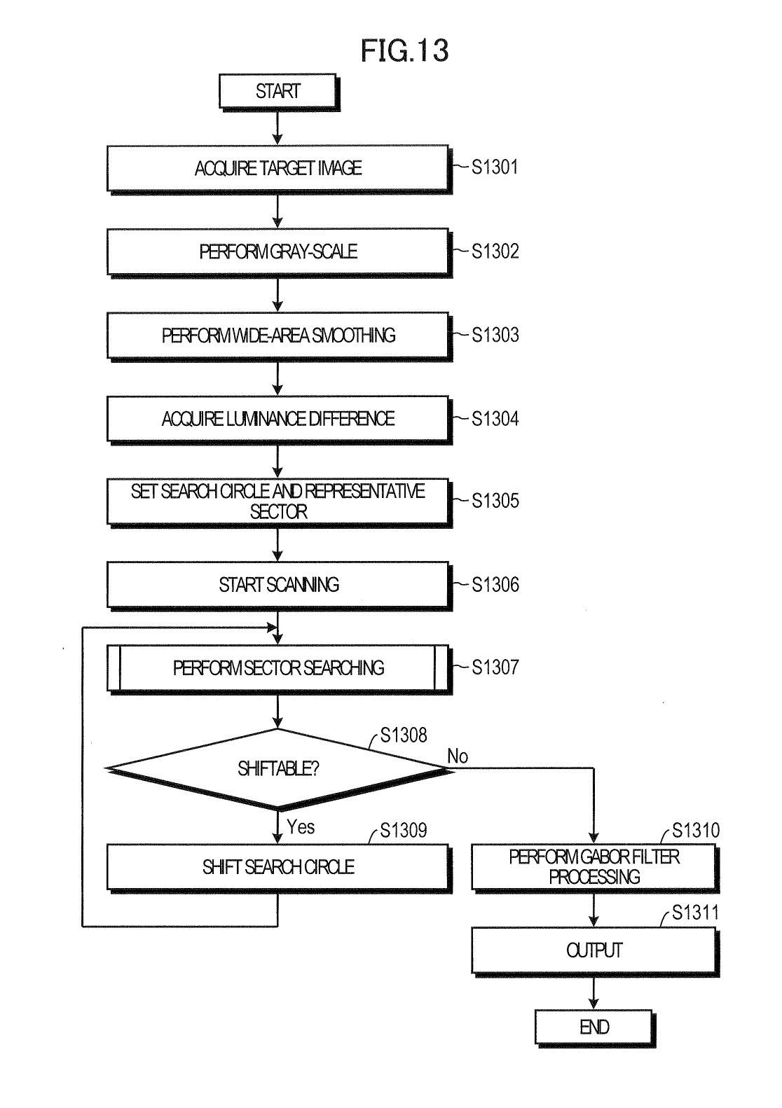

FIG. 13 illustrates an exemplary image recognizing process. In operation S1301, the image processing unit 501 acquires, for example, the target image Go illustrated in FIG. 2. The image pre-processing unit 502 gray-scales the image in operation S1302, performs wide-area smoothing in operation S1303, and acquires the luminance difference in operation S1304. In operation S1305, the setting unit 503 sets the search circle C and the representative sector f. In operation S1306, scanning using the search circle C is started.

For each scan position, a sector searching process is executed in operation S1307. In operation S1308, it is decided whether the search circle C may be shifted. When it is decided that the search circle C may be shifted (YES in operation S1308), the search circle C is shifted in operation S1309, and the process returns to operation S1307.

When it is decided that the search circle C is unable to be shifted (NO in operation S1308), the Gabor filter process executing unit 508 performs a Gabor filter process on the image corresponding to a target for Gabor filter process in operation S1310. In operation S1311, the output unit 509 outputs the result of the Gabor filter process.

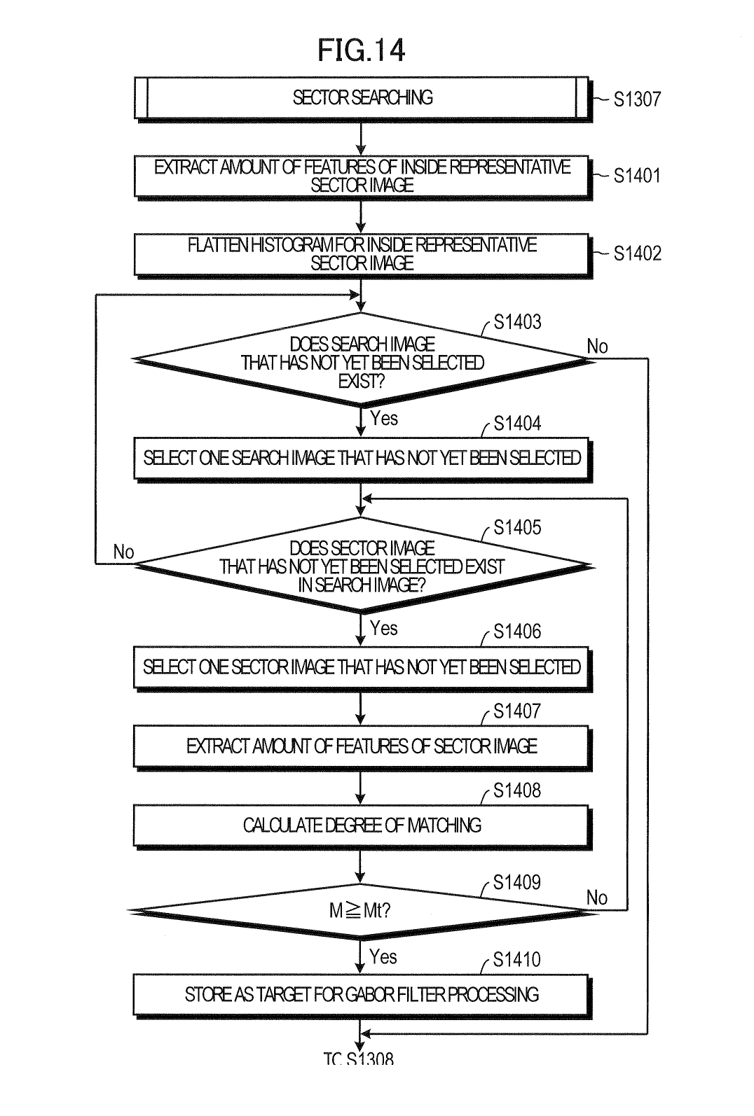

FIG. 14 illustrates an exemplary sector searching process. The sector searching process illustrated in FIG. 14 may correspond to operation S1307 illustrated in FIG. 13. In operation S1401, the extracting unit 504 extracts the value of features of the inside representative sector image g. In operation S1402, the histogram is flattened. In operation S1403, it is decided whether a not-selected search image Gr exists in the main memory 408.

When a search image Gr is not selected (YES in operation S1403), the not-selected search image Gr is selected in operation S1404. In operation S1405, it is decided whether a not-selected sector image exists in the selected search image Gr. When a sector image is not selected (YES in operation S1405), the not-selected sector image is selected in operation S1406. In operation S1407, the amount of features of the selected sector image, for example, the flattened histogram is extracted from the main memory 408.

In operation S1408, the calculating unit 511 calculates the matching degree M. When the matching degree M is calculated, the deciding unit 512 decides whether M is greater than or equal to Mt in operation S1409. When M is not greater than or equal to Mt (NO is operation S1409), the process returns to operation S1405. Operation S1405 to S1409 is repeated until a sector image with a value M is greater than or equal to Mt is detected.

When M is greater than or equal to Mt (YES in operation S1409), the image in the search circle C is stored in the main memory 408 as a target for Gabor filter process in operation S1410, and the process proceeds to operation S1308.

Operation S1405 to S1409 is repeated until a sector image whose M is greater than or equal to Mt is searched for. In operation S1405, when a not-selected sector image does not exist (NO in operation S1405), the process returns to operation S1403. In operation S1403, it is decided whether a not-selected search image Gr exists. When the not-selected search image Or does not exist (NO in operation S1403), the process proceeds to operation S1308. Because a sector image which a value M is greater than or equal to Mt is not detected, Gabor filter process may not be performed, so a particular image, for example, a face image may not recognized.

Because comparison is made between sector images, even if the orientation of the image in the search circle C and that of the search image Gr are different, a detection is performed. A complicated computation of mixture Gaussian distribution used in retinal sampling may not be performed. From the target image Go, an image that is a candidate for a face image may be searched for at high speed with low load.

A plurality of representative sectors f in a search circle C may be used. For example, three representative sectors f, which is provided equi-angularly, may be set. In this case, a representative sector f at approximately 0 to 30 degrees, a representative sector f at approximately 120 to 150 degrees, and a representative sector f at approximately 240 to 270 degrees may be set, for example.

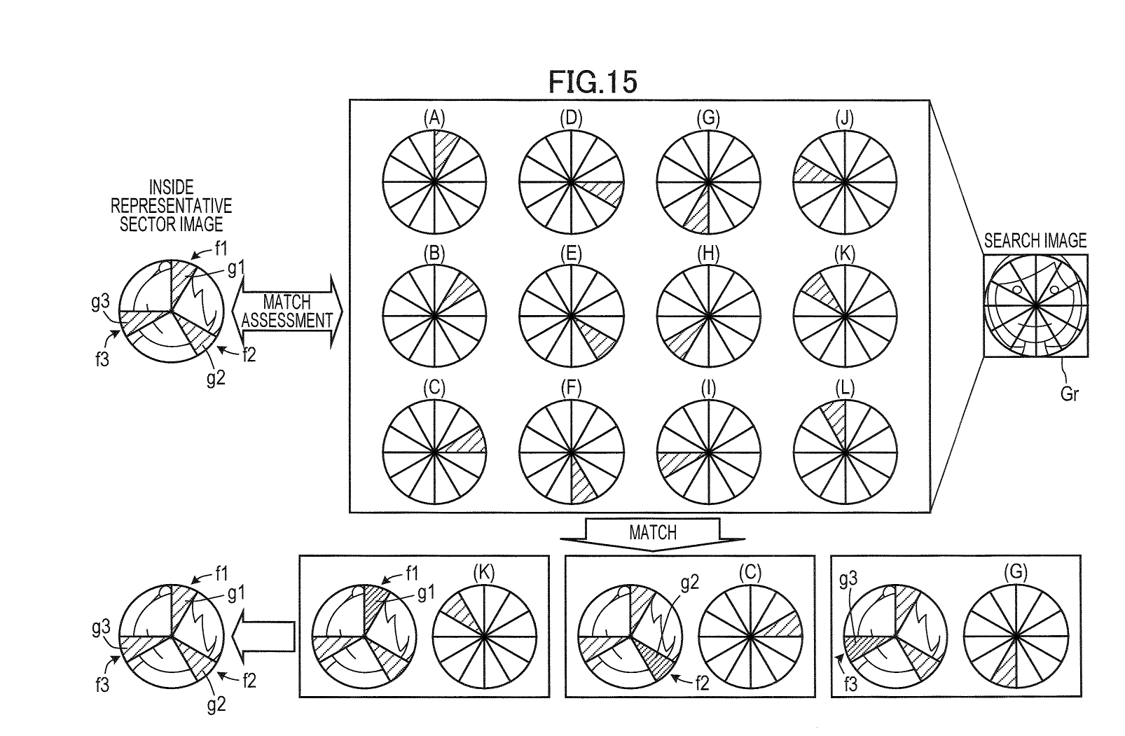

FIG. 15 illustrates an exemplary comparing process. In FIG. 15, the image in the search circle C and the image of the search image Gr are compared. The representative sector f1 among the representative sectors f1 to f3 illustrated in FIG. 15 may be the reference representative sector.

In FIG. 15, as illustrated in FIG. 3, the sector images (A) to (L) and the sector image in the representative sector f1 are compared. An image g1 in the representative sector f1 and the sector image (K) are decided to match each other because they correspond to an image of the right eye.

When the image g1 in the representative sector f1 and the sector image (K) match each other, an image g2 in the representative sector f2 and an image g3 in the representative sector f3 are compared with sector images of the search image Gr.

The image g2 in the representative sector f2 is the image at the location where the image g1 in the representative sector f1 is rotated clockwise approximately 120 degrees. Thus, a sector image in the search image Gr to be compared may be the sector image (C), which is at the location where the sector image (K), which is determined to match the image g1 in the representative sector f1, is rotated clockwise approximately 120 degrees.

The image g3 in the representative sector f3 is the image at the location where the image g1 in the representative sector f1 is rotated counterclockwise approximately 120 degrees. Thus, a sector image in the search image Gr to be compared may be the sector image (G), which is at the location where the sector image (K), which is determined to match the image g1 in the representative sector f1, is rotated counterclockwise approximately 120 degrees. The image g1 in the representative sector f1 and the sector image (K) are used as the reference, and the arrangement pattern of the images g1, g2, and g3 matches the arrangement pattern of the sector images (K), (C), and (G).

After determination of the reference representative sector f1, the representative sector f2 and the representative sector f3 are determined. If one determination is a mismatch, another determination is then made. When the proportion of match determination is equal to or larger than a threshold, the image in the search circle C is stored as a target for Gabor filter process. The use of a plurality of representative sectors f may improve accuracy of image recognition.

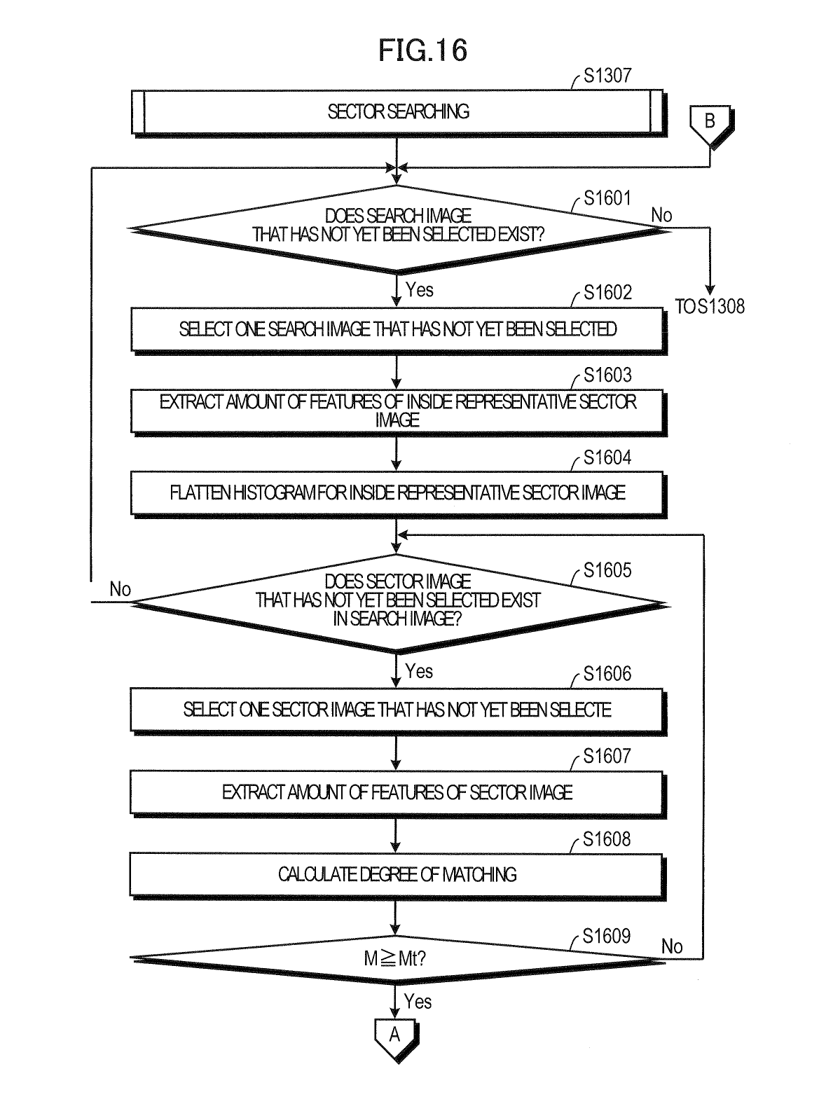

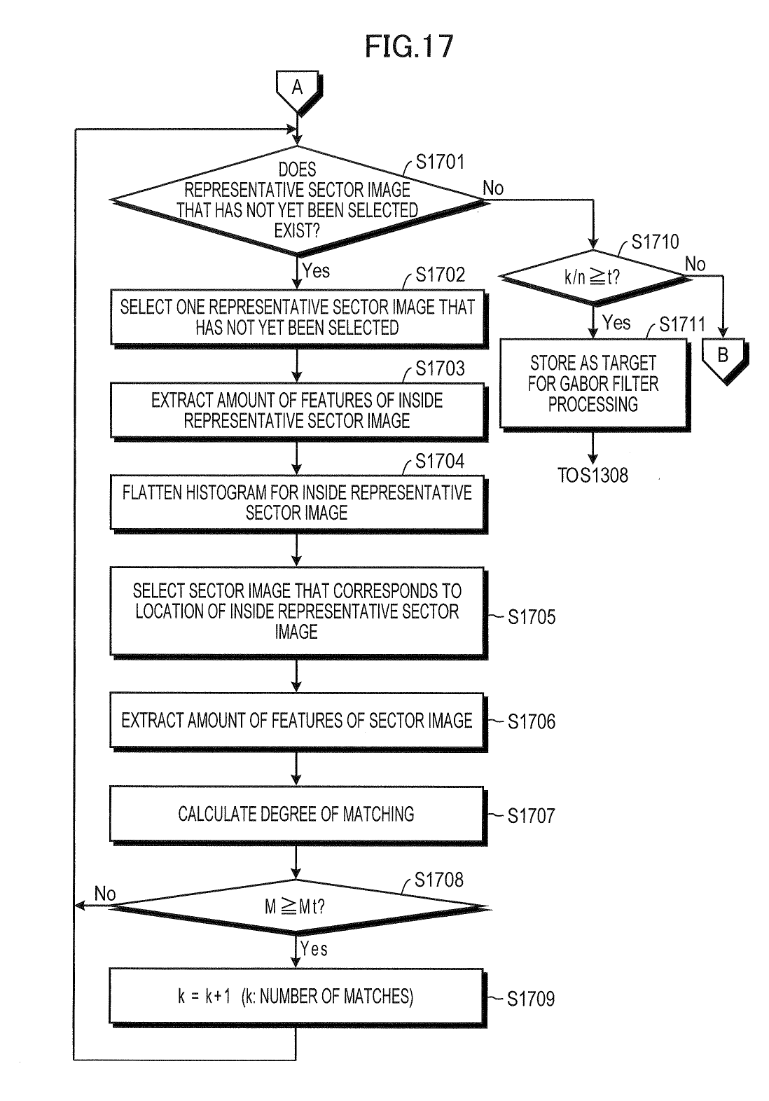

FIGS. 16 and 17 illustrate an exemplary sector searching process. In FIGS. 16 and 17, a plurality of representative sectors f are set. FIGS. 16 and 17 may correspond to operation S1307 illustrated in FIG. 13. In operation S1601, it is decided whether a not-selected search image Gr exists in the main memory 408. In operation S1602, the not-selected search image Gr is selected. The extracting unit 504 extracts the value of features of the inside representative sector image g in operation S1603. In operation S1604, the histogram is flattened.

In operation S1605, it is decided whether a not-selected sector image exists in the selected search image Gr. When a not-selected sector image exists (YES in operation S1605), the not-selected sector image is selected in operation S1606. In operation S1607, the value of features of the selected sector image, for example, the flattened histogram is extracted from the main memory 408.

In operation S1608, the calculating unit 511 calculates the matching degree M. In operation S1609, the deciding unit 512 decides whether M is greater than or equal to Mt. When M is not greater than or equal to Mt (NO in operation S1609), the process returns to operation S1605. Operation S1605 to S1609 is repeated until a sector image with a value M is greater than or equal to Mt is detected. When M is greater than or equal to Mt (YES in operation S1609), the process proceeds to operation S1701 in FIG. 17.

Operation S1605 to S1609 is repeated until a sector image with a value M is greater than or equal to Mt. In operation S1605, when a not-selected sector image does not exist (NO in operation S1605), the process returns to operation S1601, where it is decided whether a not-selected search image Or exists. When a not-selected search image Gr does not exist (NO in operation S1601), the process proceeds to operation S1308. Because no sector image with a value M is greater than or equal to Mt is detected, Gabor filter process is not performed, so a particular image, for example, a face image is not recognized.

In operation S1701, it is decided whether a not-selected sector image f exists. When a not-selected sector image f exists (YES in operation S1701), the not-selected sector image f is selected in operation S1702. The extracting unit 504 extracts the value of features of the image g in the representative sector f in operation S1703. In operation S1704, the histogram is flattened.

In operation S1705, a sector image that corresponds to the location of the image g in the selected representative sector f is selected. In operation S1706, the value of features of the sector image, for example, the flattened histogram is extracted from the main memory 408.

In operation S1707, the calculating unit 511 calculates the matching degree M. In operation S1708, the deciding unit 512 decides whether M is greater than or equal to Mt. When M is not greater than or equal to Mt (NO in operation S1708), the process returns to operation S1701, and operation S1701 to S1708 is repeated until a sector image with a value M greater than or equal to Mt is detected. When M is greater than or equal to Mt (YES in operation S1708), the number k of matches is incremented in operation S1709, and the process returns to operation S1701. Operation S1701 to S1708 is repeated.

In operation S1701, when a not-selected representative sector f does not exist (NO in operation S1701), it is decided in operation S1710 whether k/n is greater than or equal to greater than or t, where n denotes the number of representative sectors f and t denotes a threshold. When k/n is greater than or equal to t (YES in operation S1710), the image in the search circle C is stored in the main memory 408 as a target for Gabor filter process, and the process proceeds to operation S1308. When k/n is not greater than or equal to t (NO in operation S1710), the process returns to operation S1601.

Because a plurality of representative sectors f are used, accuracy in image recognition may be improved. Setting the threshold t at a high value may improve accuracy in image recognition, so the image in the search circle C may be stored as a candidate for a face image. Gabor filter process may not be performed.

In FIG. 15, when it is determined that the images g1 to g3 match the sector images (K), (C), and (G), respectively, the image in the search circle C may be stored as a target for Gabor filter process. The process ends at the time when a mismatch is detected. Accuracy in image recognition may be improved, and the process speed of image recognition may be enhanced.

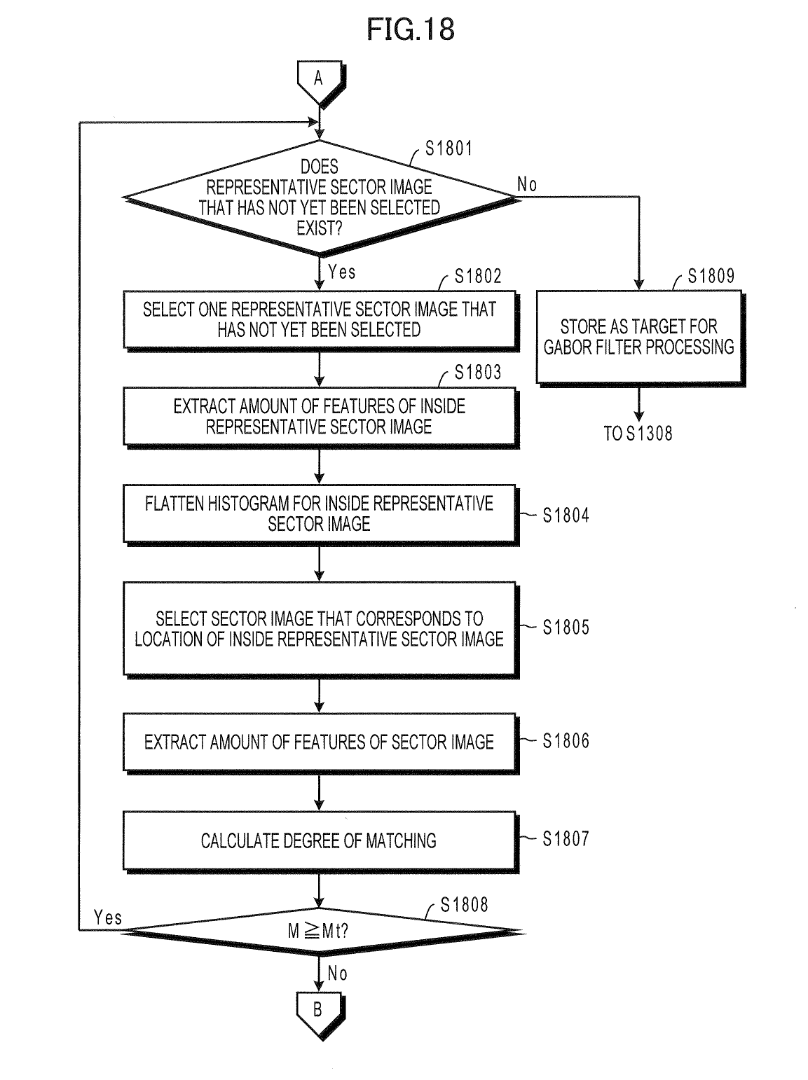

FIG. 18 illustrates an exemplary sector searching process. The sector searching process illustrated in FIG. 18 may correspond to operation S1307 illustrated in FIG. 13. A plurality of representative sectors is set. In operation S1801, it is decided whether a not-selected representative sector f exists. When a not-selected representative sector f exists (YES in operation S1801), the not-selected representative sector f is selected in operation S1802. In operation S1803, the extracting unit 504 extracts the value of features of the image g in the representative sector. In operation S1804, the histogram is flattened.

In operation S1805, a sector image that corresponds to the location of the image g in the representative sector is selected. In operation S1806, the amount of features of the sector image, for example, the flattened histogram is extracted from the main memory 408.

In operation S1807, the calculating unit 511 calculates the matching degree M. In operation S1808, the deciding unit 512 decides whether M is greater than or equal to Mt. When M is not greater than or equal to greater than or Mt (NO in operation S1808), the process returns to operation S1601, and a next search image Or is selected.

When M is greater than or equal to Mt (YES in operation S1808), the process returns to operation S1801, and operation S1801 to S1808 is repeated.

In operation S1801, when a not-selected representative sector f does not exist (NO in operation S1801), the image in the search circle C is stored in the main memory 408 as a target for Gabor filter process in operation S1809. The process proceeds to operation S1308.

The process ends at the time when a mismatch is determined. When a match is determined, the target for Gabor filter process is stored in the main memory 408. Accuracy in image recognition may be improved. When a mismatch is determined, the search image Gr is switched to another one. The process speed of image recognition may be enhanced.

The image in the search circle C may be stored as a face image. The process speed may be enhanced.

Because a sector is used, even if the orientation of the image in the search circle C and that of the search image Gr are different, determination is made. From the target image Go, a candidate image may be searched for at high speed with low load.

Because the matching degree M is calculated based on the amount of features, a complicated computation of mixture Gaussian distribution used in retinal sampling may not be performed. A candidate image may be searched for at high speed with low load.

A candidate image may be determined based on a plurality of representative sectors f. Accuracy in image recognition may be improved.

When a plurality of representative sectors f are used, the process may end at the time when a mismatch is determined. Accuracy in image recognition may be improved. When a mismatch is determined, the search image Gr may be switched to another one. The processing speed of the image recognition may be enhanced.

A particular image may include a face image viewed from the front, a face image from a perspective view, or a side-face image. The particular image may include another section of a body, a section of a creature, or an object, such as a distinctive area of a vehicle, for example. A representative sector f may have any central angle and any radius.

A search window moving on a target image Go in scanning may include a polygon, for example, regular hexagon, regular octagon, or regular decagon.

Image process is performed by execution of a program by a computer (e.g., a personal computer or work station). The program may be recorded in a computer-readable recording medium, such as a hard disk, flexible disk, compact-disk read-only memory (CD-ROM), magnetic disk, or digital versatile disc (DVD). The program may be distributed over a network, such as the Internet.

The image process apparatus 400 may be applied to an application-specific integrated circuit (ASIC) including a standard cell or structured ASIC or to a programmable logic device (PLD) including a field-programmable gate array (FPGA). For example, the above image process may be written in a hardware description language (HDL), the HDL description may be synthesized, and it may be provided to an ASIC or PLD.

Example embodiments of the present invention have now been described in accordance with the above advantages. It will be appreciated that these examples are merely illustrative of the invention. Many variations and modifications will be apparent to those skilled in the art.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. An image processing program which is executable by a computer and is stored in a recording medium readable by the computer, the image processing program comprising:
storing one or more features of a plurality of images, each image having a shape defined by a central angle whose origin is a center of a certain image;
setting at least one representative shape defined by a central angle whose origin is a center of a search window for scanning a target image;
extracting a first value of the one or more features of the representative shape;
extracting a second value of the one or more features of one of the plurality of images; and
comparing the extracted first value and the extracted second value and determining an image in the search window as an image candidate for the certain image based on a comparison result.

2. The image processing program according to claim 1, further comprising:
calculating a matching degree between the image of the representative shape and one of the plurality of images based on the first value and the second value;
deciding whether the matching degree is equal to or larger than a threshold; and
determining whether an image that substantially matches the image of the representative shape is present in the plurality of images based on a decision.

3. The image processing program according to claim 2, further comprising:
setting a plurality of representative shapes;
extracting a value of one or more features of each of the plurality of representative shapes; and
when the image that substantially matches the image of a first representative shape among the plurality of representative shapes is present in the plurality of images, determining whether an image that substantially matches an image of a second representative shape other than the first representative shape is present in the plurality of images or not, based on a value of features of the images of the second representative shape and the values of features of the plurality of images.

4. The image processing program according to claim 3, wherein the image in the search window is determined as the image candidate for the certain image based on a number of instances where the image that substantially matches one representative shape among the plurality of representative shapes is present in the plurality of images.

5. The image processing program according to claim 3, wherein the image in the search window is not determined as the image candidate for the certain image when the image that substantially matches each of the plurality of representative shapes is not present in the plurality of images.

6. The image processing program according to claim 1, further comprising:
performing Gabor filter process on the image candidate; and
outputting a result of the Gabor filter process.

7. The image processing program according to claim 1, wherein the certain image includes a face image.

8. An image processing apparatus comprising:
a storing unit that stores one or more of features of a plurality of images, each image having a shape defined by a central angle whose origin is a center of a certain image;
a setting unit that sets at least one representative shape defined by a central angle whose origin is a center of a search window for scanning a target image;
a first extracting unit that extracts a value of the one or more features of the representative shape;
a second extracting unit that extracts a value of the one or more features of the plurality of images; and
a determining unit that compares the value of features of the representative shape and the value of features of one of the plurality of images and determining an image in the search window as an image candidate for the certain image based on a comparison result.

9. The image processing apparatus according to claim 8, further comprising:
a calculating unit that calculates a matching degree of between the image of the representative shape and one of the plurality of images based on a first value of features of the representative shape and a second value of features of one of the plurality of images; and
a determining unit that deciding whether the matching degree is equal to or larger than a threshold and determining whether an image that substantially matches the image of the representative shape is present in the plurality of images based on a decision.

10. The image processing apparatus according to claim 9, wherein the setting unit sets a plurality of representative shapes, the first extracting unit extracts a value of one or more features of each of the plurality of representative shapes, and, when an image that substantially matches an image of a first representative shape among the plurality of representative shapes is present in the plurality of images, the determining unit determines whether an image that substantially matches an image of a second representative shape other than the first representative shape is present in the plurality of images or not based on the value of features of an image of the second representative shape and the values of features of the plurality of images

11. The image processing apparatus according to claim 10, wherein the determining unit determines whether an image in the search window is an image candidate for the certain image based on a number of instances where an image that substantially matches each of the plurality of representative shapes is present in the plurality of images.

12. The image processing apparatus according to claim 10, wherein, when an image that substantially matches one of the plurality of representative shapes is not present in the plurality of images, the determining unit determines that the image in the search window is not the image candidate for the certain image.

13. An image processing method executable by a computer, the image processing method comprising:
storing one or more of features of a plurality of images, each image having a shape defined by a central angle whose origin is a center of a certain image;
setting at least one representative shape defined by a central angle whose origin is a center of a search window for scanning a target image;
extracting a first value of the one or more features of the representative shape;
extracting a second value of the one or more features of one of the plurality of images; and
comparing the extracted first value and the extracted second value and determining whether an image in the search window is an image candidate for the certain image based on a comparison result.
